(19) United States
(12) Patent Application Publication
(10) Pub. No.: US 2020/0190369 A1
(43) Pub. Date: Jun. 18, 2020

(54) 1,1 DISUBSTITUTED ALKENE COMPOUND BASED PRESSURE SENSITIVE ADHESIVES

(71) Applicant: Sirrus, Inc., Loveland, OH (US)

(72) Inventors: Katherine E. King, Cincinnati, OH (US); Aniruddha S. Palsule, Cincinnati, OH (US); Mark R. Holzer, Lowell, AR (US); Jessica Elena Carson, Cincinnati, OH (US)

(21) Appl. No.: 16/716,232

(22) Filed: Dec. 16, 2019

Related U.S. Application Data
(60) Provisional application No. 62/780,816, filed on Dec. 17, 2018.

(51) Int. Cl. C09J 7/38; C09J 4/00

(52) U.S. Cl. CPC C09J 7/381; C08L 35/02; C09J 4/00

(57) ABSTRACT

A solventless pressure sensitive adhesive composition is provided, having from about 65% to about 99.5%, by weight, of a first monomer comprising 1,1-disubstituted alkene monomer with a low Tg and from about 0.5% to about 25%, by weight, of a second monomer comprising 1,1-disubstituted alkene monomer with an elevated Tg. The composition also contains a 1,1-disubstituted alkene multifunctional crosslinker.

### CROSS-REFERENCE TO RELATED APPLICATIONS

The present application claims the priority of U.S. provisional patent application Ser. No. 62/780,816, entitled 1,1-DISUBSTITUTED ALKENE COMPOUND BASED PRESSURE SENSITIVE ADHESIVES, filed Dec. 17, 2018, and hereby incorporates the same application herein by reference in its entirety.

### TECHNICAL FIELD

The present disclosure generally relates to compositions of 1,1-disubstituted alkene compounds for use as pressure sensitive adhesives.

### BACKGROUND

Pressure sensitive adhesive (“PSA”) compositions are known adhesives where the application of pressure is used to form bonds with a substrate surface. PSAs are useful for many applications including tapes, labels, medical devices, and graphics. Conventional PSAs are derived from several classes of materials that include rubber (natural or synthetic), acrylics, and silicones. Such conventional PSAs typically require solvents and/or the use of heat and light energy in the manufacturing process.

Conventional PSAs have numerous drawbacks. For example, although solvent based PSAs can crosslink, such solvent based PSAs often use chemicals resulting in shorter pot life. To mitigate this, it is known to use a two-part system to ensure quality and stability. The use of certain solvents also may require monitoring and reporting of volatile organic compounds (VOCs). For certain hot melt PSA adhesives, which are generally 100% solids, application of UV light is needed to induce crosslinking after the resin has been dispensed onto the desired substrate, which requires additional manufacturing capital and equipment. Water based PSAs cannot crosslink.

The compositions and processes herein have overcome some of the disadvantages of conventional processing of PSAs, for example monitoring VOC is avoided, heating equipment is not necessary, and other energy intensive equipment such as a UV light source is not needed.

### SUMMARY

According to one aspect, a solventless pressure sensitive adhesive (PSA) composition is provided comprising:

from about 65% to about 99.5%, by weight of a first monomer comprising 1,1-disubstituted alkene monomer of formula III, having a Tg, preferably from about −60° C. to about 10° C.;

from about 0.5% to about 25%, by weight of a second monomer comprising 1,1-disubstituted alkene monomer of formula III, preferably having a Tg from about 23° C. to about 150° C.; and

from about 0.1% to about 20% of a 1,1-disubstituted alkene multifunctional crosslinker.

### BRIEF DESCRIPTION OF THE DRAWINGS

FIG. 1 depicts a graph comparing the storage modulus and loss modulus of example solventless PSA formulations.

### DETAILED DESCRIPTION

### Definitions

As used herein “rigid” with respect to the second monomer of 1,1-disubstituted alkene compound means that the second monomer has an elevated Tg and is inflexible as compared to the first monomer of 1,1-disubstituted alkene compounds having a low Tg.

As used herein “tacky” with respect to the first monomer of 1,1-disubstituted alkene compound means that the first monomer has a low Tg and is tacky as compared to the second monomer of 1,1-disubstituted alkene compounds having a high Tg.

As used herein “solventless PSA” means that the PSA coating contains about 5% or less, about 3% or less, about 1% or less, or about 0.5% or less, of the particular solvent material, such as DMSO, tetrahydrofuran, heptane, toluene, dimethoxy ethane, dichloromethane, etc.

As will be described herein, solventless PSA compositions are disclosed. As will be appreciated, the application, or formation, of a solventless PSA thin polymeric films to, or on, substrates can provide such substrates, and articles containing such substrates, with a variety of beneficial properties and improvements. For example, solventless PSA coatings may be provided onto a wide variety of substrates that cannot easily be coated by other techniques. As can be appreciated, the elimination of solvent can reduce side reactions that can occur in solution and the need to evaporate excess solvent from the system.

In certain aspects, the solventless PSA compositions can be formed from a mixture of 1,1-disubstituted alkene compounds. The use of more than one 1,1-disubstituted alkene monomer can be useful to tailor the PSA properties of the polymeric film deposited on a substrate. For example, the use of more than one 1,1-disubstituted alkene monomer can enhance the properties of the polymeric film by blending multiple properties such as multiple glass transition temperatures or levels of tackiness. For example, a blend of more 1,1-disubstituted alkene compounds can be used to have a final blended Tg of about −20° C. to about 20° C. in certain aspects. The use of multiple 1,1-disubstituted alkene compounds for other applications are disclosed in U.S. Pat. No. 9,315,597 and PCT Patent App. Pub. No. WO 2016/040261, both incorporated herein by reference.

According to certain aspects, a solventless PSA composition can be formed of multiple 1,1-disubstituted alkene compounds that form polymers having different glass transition temperatures (“Tg”). For example, a solventless PSA composition can be formed of 1,1-disubstituted alkene compounds that polymerize to a low temperature Tg polymer or polymerize to an elevated temperature Tg polymer (hereinafter “low Tg 1,1-disubstituted alkene compounds” and “elevated Tg 1,1-disubstituted alkene compounds” respectively). In certain aspects, it can also be advantageous to form a solventless PSA composition formed of a blend of both low Tg 1,1-disubstituted alkene compounds and elevated Tg 1,1-disubstituted alkene compounds.

In other aspects where a solventless PSA composition includes a blend of both low Tg and elevated Tg, 1,1-disubstituted alkene compounds, the solventless PSA composition can include various quantities of low Tg and elevated Tg, 1,1-disubstituted alkene compounds. For example, in certain aspects, about 75% to about 99.5%, or from about 80% to about 99%, by weight, of a solventless PSA composition can be formed of low Tg 1,1-disubstituted alkene compounds such as hexyl methyl methylene malonate. In certain aspects, about 90% to about 97.5%, by weight, of a reactive composition can be formed of low Tg 1,1-disubstituted alkene compounds. A low Tg 1,1-disubstituted alkene compound can have a Tg of about 0° C. or less according to certain aspects, or a Tg of about −10° C. or less according to certain aspects. Examples of suitable low Tg 1,1-disubstituted alkene compounds can include methylmethoxy ethyl methylene malonate (0° C.), ethylethoxy ethyl methylene malonate (−18° C.), hexyl methyl methylene malonate (−34° C.), and dihexyl methylene malonate (<−45° C.). In one aspect the low Tg may range from about −80° C. to about 10° C. or from about −60° C. to about 0° C.

In such solventless PSA compositions having a blend of low Tg and elevated Tg 1,1-disubstituted alkene compounds, at least a portion of the remaining solventless PSA composition can be the elevated Tg 1,1-disubstituted alkene compounds. For example, in certain aspects about 0.5% to about 25%, by weight, or from about 1% to about 12%, of the solventless PSA composition can be an elevated Tg 1,1-disubstituted alkene compound. In certain aspects, about 2.5% to about 5%, by weight, of the solventless PSA composition can be an elevated Tg 1,1-disubstituted alkene compound. Elevated Tg 1,1-disubstituted alkene compounds can have a Tg of about room temperature (e.g., about 23° C.) or greater in certain aspects, a Tg of about 30° C. or greater in certain aspects, or a Tg of about 50° C. or greater in certain aspects. In one aspect the elevated Tg may range from about 60° C. to about 150° C. or from about 80° C. to about 140° C.

Non-limiting examples of suitable elevated Tg 1,1-disubstituted alkene compounds can include diethyl methylene malonate (35° C.), dimethyl methylene malonate (55° C.), phenylpropyl methyl methylene malonate (50-70° C.), menthyl methyl methylene malonate (125-135° C.), fenchyl methyl methylene malonate (140-190° C.) and dicyclohexyl methylene malonate (140-190° C.). Certain elevated Tg 1,1-disubstituted compounds can be suitable due to crosslinking with difunctional or multifunctional 1,1-disubstituted alkene compounds. For example, the substitution of a diethyl methylene malonate composition (Tg of 35° C.) with about 10% difunctional pentane or hexane linked ethyl methylene malonate can increase the Tg of the diethyl methylene malonate composition by about 10° C. to reach an elevated Tg of about 45-50° C. and can be used as an elevated Tg 1,1-disubstituted alkene compound.

The solventless PSA adhesives described herein can further include a crosslinking agent. Advantageously, the crosslinking agent can be a 1,1-disubstituted alkene multifunctional crosslinker. The use of such a crosslinker can improve the transfer characteristics, durability, and strength of the PSA.

Generally, in certain aspects, the described PSA compositions and processes can form thin polymeric layers from one or more 1,1-disubstituted alkene compounds functioning as reactive monomers and one or more polymerization initiators which initiate polymerization of the 1,1-disubstituted alkene compounds. The 1,1-disubstituted alkene compounds can deposit on a substrate following activation to form a thin PSA polymeric film on the substrate.

As used herein, 1,1-disubstituted alkene compounds can generally refer to any compounds having two carbonyl groups bonded to the 1 carbon and a hydrocarbyl group bonded to each of the carbonyl groups. In such 1,1-disubstituted alkene compounds, the hydrocarbyl groups can be bonded to the carbonyl groups directly or through an oxygen atom.

According to certain aspects, suitable hydrocarbyl groups for the one or more 1,1-disubstituted alkene compounds can include at least straight or branched chain alkyl groups, straight or branched chain alkyl alkenyl groups, straight or branched chain alkynyl groups, cycloalkyl groups, alkyl substituted cycloalkyl groups, aryl groups, aralkyl groups, and alkaryl groups. Additionally, suitable hydrocarbyl groups can also contain one or more heteroatoms in the backbone of the hydrocarbyl group.

In certain aspects, a suitable hydrocarbyl group can also, or alternatively, be substituted with a substituent group. Non-limiting examples of substituent groups can include one or more alkyl, halo, alkoxy, alkylthio, hydroxyl, nitro, cyano, azido, carboxy, acyloxy, and sulfonyl groups. In certain aspects, substituent groups can be selected from one or more alkyl, halo, alkoxy, alkylthio, and hydroxyl groups. In certain aspects, substituent groups can be selected from one or more halo, alkyl, and alkoxy groups.

In certain aspects, suitable hydrocarbyl groups can be C₁₋₂₀ hydrocarbyl groups. For example, the hydrocarbyl group can be an alkyl ether having one or more alkyl ether groups or alkylene oxy groups. Suitable alkyl ether groups can include, without limitation, ethoxy, propoxy, and butoxy groups. In certain aspects, suitable hydrocarbyl groups can contain about 1 to about 100 alkylene oxy groups; in certain aspects, about 1 to about 40 alkylene oxy groups; and in certain aspects, about 1 to about 10 alkylene oxy groups. In certain aspects, suitable hydrocarbyl groups can contain one or more heteroatoms in the backbone.

Suitable examples of more specific hydrocarbyl groups can include, in certain aspects, C₁₋₁₅ straight or branched chain alkyl groups, C₁₋₁₅ straight or branched chain alkenyl groups, C₅₋₁₈ cycloalkyl groups, C₆₋₂₄ alkyl substituted cycloalkyl groups, C₄₋₁₈ aryl groups, C₄₋₂₀ aralkyl groups, and C₄₋₂₀ alkaryl groups. In certain aspects, the hydrocarbyl group can more preferably be C₁₋₈ straight or branched chain alkyl groups, C₅₋₁₂ cycloalkyl groups, C₆₋₁₂ alkyl substituted cycloalkyl groups, C₄₋₁₈ aryl groups, C₄₋₂₀ aralkyl groups, or C₄₋₂₀ alkaryl groups.

As used herein, alkaryl can include an alkyl group bonded to an aryl group. Aralkyl can include an aryl group bonded to an alkyl group. Aralkyl can also include alkylene bridged aryl groups such as diphenyl methyl or propyl groups. As used herein, aryl can include groups containing more than one aromatic ring. Cycloalkyl can include groups containing one or more rings including bridge rings. Alkyl substituted cycloalkyl can include a cycloalkyl group having one or more alkyl groups bonded to the cycloalkyl ring.

In certain aspects, suitable alkyl groups can include methyl, ethyl, propyl, isopropyl, butyl, tertiary butyl, pentyl, hexyl, and ethyl hexyl. Similarly, examples of suitable cycloalkyl groups can include cyclohexyl and fenchyl groups. Examples of suitable alkyl substituted groups can include menthyl and isobornyl groups.

According to certain aspects, suitable hydrocarbyl groups can include methyl, ethyl, propyl, isopropyl, butyl, tertiary butyl, ethyl pentyl, hexyl, ethyl hexyl, fenchyl, menthyl, and isobornyl groups.

In certain aspects, illustrative examples of 1,1-disubstituted alkene compounds suitable for use as a reactive monomer in a solventless PSA can include methylene malonates, methylene β-ketoesters, methylene β-di-ketones, di-alkyl di-substituted vinyls, di-haloalkyl di-substituted vinyls and any monofunctional, difunctional, or multifunctional monomers, oligomers, or polymers thereof. As can be appreciated, multiple 1,1-disubstituted alkene monomers, such as two or more different methylene malonates, can also be used as the reactive monomers herein.

Suitable 1,1-disubstituted alkene compounds can be monofunctional, difunctional, or multifunctional. Monofunctional compounds can refer to monomers that have a single addition polymerizable group. Difunctional compounds can refer to monomers, oligomers, resins, or polymers that contain two addition polymerizable groups. Multifunctional compounds can refer to any monomer, oligomer, resin, or polymer that contains three or more addition polymerizable groups. In contrast to monofunctional compounds, certain difunctional compounds and multifunctional compounds can undergo crosslinking, chain extension, or both when exposed to certain suitable polymerization initiators. As can be appreciated, selection of a monofunctional, difunctional, or multifunctional monomer can determine properties such as the durability of the applied coating layer, the reactivity of the monomer with other additives, and the adhesion strength to a substrate.

As can be appreciated, the purity of a 1,1-disubstituted alkene compound can affect the polymerization process. For example, the purity of the 1,1-disubstituted alkene compounds can influence the glass transition temperature of the polymerized product formed from the 1,1-disubstituted alkenes. In certain aspects, the purity of a 1,1-disubstituted alkene compound can be sufficiently high such that about 70 mole percent or more, in certain aspects, 80 mole percent or more, in certain aspects, about 90 mole percent or more, in certain aspects, about 95 mole percent or more, and in certain aspects, about 99 mole percent or more of the 1,1-disubstituted alkene compound is converted to polymer during a polymerization process.

Additionally, or alternatively, the purity of a 1,1-disubstituted alkene compound can be measured by determining the mole percent that is formed from the monomer. For example, about 85 mole percent or more, about 90 mole percent or more, about 93 mole percent or more, about 95 mole percent or more, about 97 mole percent or more, and about 99 mole percent or more, of the reactive monomer can be a 1,1-disubstituted alkene compound in certain aspects.

If impurities are present, the impurity can be about 10 mole percent or less in certain aspects, and about 1 mole percent or less in certain aspects. In aspects having a dioxane group impurity, the dioxane group can be present at about 2 mole percent or less, about 1 mole percent or less, about 0.2 mole percent or less, and about 0.05 mole percent or less, based on the total moles of the 1,1-disubstituted alkene compound. The total concentration of any impurity having the alkene group replaced by an analogous hydroxyalkyl group (e.g., by a Michael addition of the alkene with water) can be about 3 mole percent or less, about 1 mole percent or less, about 0.1 mole percent or less, and about 0.01 mole percent or less, based on the total moles in the 1,1-disubstituted alkene compound.

In certain aspects, 1,1-disubstituted alkene compounds can be prepared by a process including one or more (e.g., two or more) steps of distilling a reaction product or an intermediate reaction product (e.g., a reaction product or intermediate reaction product of a source of formaldehyde and a malonic acid ester).

An illustrative example of a monofunctional 1,1-disubstituted alkene compound is depicted by general formula I:

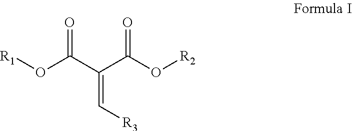

wherein each X can independently be O or a direct bond; R₁ and R₂ can be the same or different and can each represent a hydrocarbyl group; and R₃ can be H, a C₁-C₈ alkyl, or a hydrocarbyl.

An illustrative example of a multifunctional monomer having more than one methylene group connected by a multivalent hydrocarbyl group is depicted by general formula II:

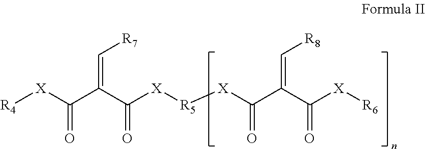

wherein each X can independently be O or a direct bond; R₄ and R₆ can be the same or different and can each represent a hydrocarbyl group; R₅ can be a hydrocarbyl group having n+1 valences; R₆ and R₇ can independently be H, a C₁-C₈ alkyl, or a hydrocarbyl; and n is an integer of 1 or greater. In certain aspects, n can be 3 or fewer; and in certain aspects, n can be 2 or fewer.

According to certain aspects, specific examples of suitable solventless PSA compositions can include methylene malonate compounds having general formula III

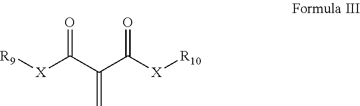

wherein R₉ and R₁₀ can be the same or different and can each represent a hydrocarbyl group and wherein each X is oxygen. For example, in certain more specific aspects, suitable methylene malonate compounds can include one or more of diethyl methylene malonate (“DEMM”), dimethyl methylene malonate (“DMMM” or “D3M”), hexyl methyl methylene malonate (“HMMM”), ethylethoxy ethyl methylene malonate (“EEOEMM”), fenchyl methyl methylene malonate (“FMMM”), dibutyl methylene malonate (“DBMM”), di-n-propyl methylene malonate, di-isopropyl methylene malonate, and dibenzyl methylene malonate. Additionally, in certain aspects, certain transesterification reaction products formed from the reaction of methylene malonate compounds with acetates, diacetates, alcohols, diols, and polyols can also be used to form a suitable reactive monomer including the products disclosed in U.S. Pat. No. 9,416,091 which is incorporated herein by reference.

According to certain aspects, examples of suitable methylene beta ketoesters can be represented by general formula IV:

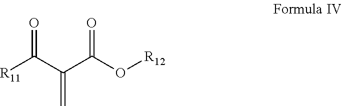

wherein R₁₁ and R₁₂ can be the same or different and can each represent a hydrocarbyl group.

According to certain aspects, examples of suitable methylene beta diketones can be represented by general formula V:

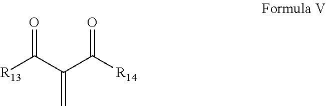

wherein R₁₃ and R₁₄ can be the same or different and can each represent a hydrocarbyl group.

Additional details and methods of making suitable 1,1-disubstituted alkene compounds as well as other suitable reactive monomers are disclosed in U.S. Pat. Nos. 8,609,885; 8,884,051; and WO 2014/110388 each of which are hereby incorporated herein by reference.

As can be appreciated, 1,1-disubstituted alkene compounds can exhibit a variety of properties that make them particularly suitable for use as reactive monomers in a solventless PSA. For example, polymerized 1,1-disubstituted alkene compounds can exhibit excellent mechanical properties including chemical and/or water resistance, chemical and/or water affinity, excellent adhesion properties, and can tolerate modifications to adjust microscale and macroscale properties.

1,1-disubstituted alkene compounds are also beneficial reactive monomers because they can be stable in both liquid and vaporized states and can remain non-reactive with any co-precursors and components of a coating system. For example, stability of the monomers in a liquid state can influence the shelf life of the monomers while stability in the vapor state can influence the conditions necessary for deposition as well as the properties of the polymeric film. Specifically, vapor phase stability can influence the molecular weight and polydispersity of the polymeric film. 1,1-disubstituted alkene monomers can generally exhibit a long shelf life.

In certain aspects, stabilizers can be included to improve the stability of the 1,1-disubstituted alkene monomers. Stabilizers can improve the shelf life and prevent spontaneous polymerization. Liquid phase stabilizers can generally be selected from anionic polymerization inhibitors such as methanesulfonic acid (“MSA”) and free-radical stabilizers such as 4-methoxyphenol or mono methyl ether of hydroquinone (“MeHQ”). Vapor phase stabilizers can be selected from at least acidic vapor phase stabilizers such as sulfur dioxide and trifluoroacetic acid (“TFA”). Additional details about suitable stabilizers for 1,1-disubstituted alkene monomers are disclosed in U.S. Pat. Nos. 6,458,956; 8,609,885; and 8,884,051 each incorporated by reference herein. Generally, the selection and quantity of stabilizers included with the monomer, or system, can balance the stabilizing effects of the stabilizers against any detriments caused by the presence of impurities in the monomer and polymerized product. In certain aspects, the quantity and selection of stabilizers can also be varied to influence the microscale properties such as the molecular weight and polydispersity of the polymerized films.

The compositions and processes described herein can involve polymerization of a 1,1-disubstituted alkene reactive monomer in situ at the surface of a substrate in a surface synthesis process. Polymerization of the reactive monomers can occur by reaction of the one or more 1,1-disubstituted alkene monomers with suitable polymerization initiators.

As will be appreciated, a wide variety of polymerization initiators can initiate polymerization of 1,1-disubstituted alkene reactive monomers. Generally, 1,1-disubstituted alkenes and compositions including such 1,1-disubstituted alkenes can undergo anionic polymerization when exposed to basic initiators. Details of suitable polymerization activators and methods of initiating polymerization of 1,1-disubstituted alkene compositions are disclosed in U.S. Pat. No. 9,181,365 which is incorporated herein by reference in its entirety.

Examples of suitable polymerization initiators which can initiate polymerization of 1,1-disubstituted alkene reactive monomers can include weak anionic compounds (i.e., metal carboxylates, sodium benzoate, and metal halides) and neutral nucleophiles (i.e., secondary and tertiary amines and phosphines). Alternatively, free radical initiators can be used to initiate free radical polymerization. Examples of suitable polymerization initiators can include sodium acetate; potassium acetate; acid salts of sodium, potassium, lithium, copper, and cobalt; tetrabutyl ammonium fluoride, chloride, and hydroxide; secondary or tertiary amines; salts of polymer bound acids; benzoate salts (e.g., sodium benzoate; potassium benzoate); 2,4-pentanedionate salts; sorbate salts; propionate salts; secondary aliphatic amines; piperidine, piperazine, N-methylpiperazine, dibutylamine, morpholine, diethylamine, pyridine, tri-ethylamine, tripropylamine, triethylenediamine, N,N-dimethylpiperazine; salts of amines with organic monocarboxylic acids; piperidine acetate; guanidines, such as tetramethyl guanidine, metal salts of a lower monocarboxylic acid; copper(II) acetate, cupric acetate monohydrate, potassium acetate, zinc acetate, zinc chloroacetate, magnesium chloroacetate, magnesium acetate; salts of acid containing polymers; salts of polyacrylic acid co-polymers, and pigments having a basic character. Compounds having basic character can be one or more amines or polyamines. For example, compounds having basic character can be one or more polyalkyleneimines, such as polyethylenimines.

In aspects wherein the polymerizable composition is a 1,1-disubstituted alkene compound, a wide variety of polymerization initiators can be suitable including most nucleophilic initiators capable of initiating anionic polymerization. For example, suitable initiators include alkali metal salts, alkaline earth metal salts, ammonium salts, amine salts, halides (halogen containing salts), metal oxides, and mixtures containing such salts or oxides. Exemplary anions for such salts include anions based on halogens, acetates, benzoates, sulfur, carbonates, silicates and the like. The mixtures containing such salts can be naturally occurring or synthetic. Specific examples of suitable polymerization initiators for 1,1-disubstituted alkene compounds can include glass beads (being an amalgam of various oxides including silicon dioxide, sodium oxide, and calcium oxide), ceramic beads (comprised of various metals, nonmetals, and metalloid materials), clay minerals (including hectorite clay and bentonite clay), and ionic compounds such as sodium silicate, sodium benzoate, and calcium carbonate. Other polymerization initiators can also be suitable including certain plastics (e.g., ABS, acrylic, and polycarbonate plastics) and glass-fiber impregnated plastics. Additional suitable polymerization initiators for such polymerizable compositions are also disclosed in U.S. Patent App. Publication No. 2015/0073110, which is hereby incorporated by reference.

As can be appreciated, certain substrates can also inherently act as a polymerization initiator and initiate polymerization of a 1,1-disubstituted alkene monomer. For example, basic glass substrates can initiate polymerization of a 1,1-disubstituted alkene monomer without requiring the addition of a separate polymerization initiator. As can be appreciated, a variety of other substrates can also inherently initiate polymerization of a 1,1-disubstituted monomer including, for example, plastics such as certain polycarbonate and acrylonitrile butadiene styrene plastics.

As can be further appreciated, substrates can also, or alternatively, be modified to act as an inherent polymerization activator in certain aspects. For example, polymerization initiators can be incorporated into a substrate as disclosed in U.S. Patent App. Pub. No. 2015/0210894, which is hereby incorporated herein by reference.

In certain aspects, polymerization can also be initiated using non-chemical reaction initiators. For example, radiation or electron beams can be used to initiate polymerization of a 1,1-disubstituted monomer. Advantageously, electricity can also be used to initiate polymerization of 1,1-disubstituted alkene monomers as described in U.S. Pat. No. 9,217,098 which is hereby incorporated by reference herein.

Suitable polymerization initiators can be monofunctional, difunctional, trifunctional, or multifunctional in certain aspects. As used herein, functionality of the polymerization initiator indicates the number of initiating sites included on each polymerization initiator. As can be appreciated, functionality of a polymerization initiator can influence the relative amounts of chain entanglement and crosslinking experienced by a reactive monomer. Functionality can also influence the relative quantity of polymerization initiator necessary.

In certain aspects, liquid polymerization initiators can be preferred. As can be appreciated, liquid polymerization initiators can be beneficial because such initiators can be free of solvent and can produce polymeric thin films of extremely high purity. For example, in certain aspects, a liquid tertiary amine or a liquid heterocyclic amine such as 1,8-diazabicyclo[5.4.0]undec-7-ene (“DBU”) and 1,5-diazabicyclo[4.3.0]non-5-ene (“DBN”) can be used as a liquid polymerization initiator.

In certain aspects, it can be useful to utilize difunctional or multifunctional 1,1-disubstituted alkene monomers. As can be appreciated, the use of difunctional or multifunctional monomers can increase the amount of crosslinking between the monomers and can produce different polymer properties. For example, the use of multifunctional monomers can improve the durability of coatings and can improve the resistance of the coatings to degradation. In certain aspects, about 5%, by weight, or more of the 1,1-disubstituted alkene monomers can be difunctional or multifunctional monomers. In certain aspects, about 10%, by weight, or more of the disubstituted alkene monomers can be difunctional or multifunctional.

As can be appreciated, it can also be advantageous in certain aspects to minimize the quantity of difunctional or multifunctional monomers. In certain aspects, about 30%, by weight, or less of the 1,1-disubstituted alkene monomers can be difunctional or multifunctional. In certain aspects, about 20%, by weight, or less of the 1,1-disubstituted alkene monomers can be difunctional or multifunctional.

The described PSAs do not damage substrates and can be useful for tapes, labels, medical devices, and graphics applications.

In certain aspects, the amount of polymerization can also be varied by modifying the temperature of the reactive monomer and/or the reaction initiator. As can be appreciated, heating the reactive monomer or the reaction initiator can increase the rate of polymerization.

Additionally, or alternatively, injection of a polymerization initiator can be terminated in certain aspects after a set period of time while still supplying additional reactive monomer. As can be appreciated, certain 1,1-disubstituted alkene monomers can undergo living anionic polymerization which will continue to polymerize additional reactive monomer even in the absence of any polymerization initiators.

Alternatively, in certain aspects, a polymerization initiator can be applied to a substrate of an article in a solid or liquid form. In such surface synthesis aspects, 1,1-disubstituted alkene monomer can polymerize upon contact with the liquid or solid polymerization initiator on the substrate to form a polymeric PSA film.

Surface synthesis processes may comprise a two-step process requiring (1) application of the polymerization initiator and (2) subsequent deposition of the reactive monomer.

Surface synthesis processes can exhibit several advantages. For example, deposition of a PSA (e.g. as a polymeric film) can be easily limited to specific portions of a substrate through selective application of a polymerization initiator. As can be appreciated, multiple PSA polymeric films exhibiting different adhesive or other qualities can be applied to a substrate using selective placement of polymerization initiator and multiple surface synthesis processes.

As can be appreciated, surface synthesis processes can form polymeric films that are capable of initiating further polymerization as a consequence of certain 1,1-disubstituted alkene monomers undergoing living anionic polymerization. In such aspects, any additional reactive monomers depositing on a polymeric film still undergoing living anionic polymerization will begin polymerizing on top of the initial film without requiring the injection of any additional polymerization initiators. As can be appreciated, unique coatings can be applied to a substrate by temporarily pausing the addition of monomer and then supplying additional reactive monomer.

The additional reactive monomers can include 1,1-disubstituted alkene monomers different than the 1,1-disubstituted alkene monomers of the initial polymeric film, 1,1-disubstituted alkene monomers identical to the monomers of the initial polymeric film, and any other reactive monomer that can be initiated by living free radical polymerization process.

PSA effectiveness may be optimized by selection of the reactive monomer and polymerization initiator. For example, a blend of multiple 1,1-disubstituted alkene monomers each having a different glass transition temperature can be selected to ensure there is strong mechanical adhesion caused by tacky polymers according to the type of PSA application that is desired.

In certain aspects, a composition having a 1,1-disubstituted alkene compound can include one or more additives including, for example, one or more dyes, adhesion promotors, tackifiers, pigments, toughening agents, impact modifiers, rheology modifiers, plasticizing agents, natural or synthetic rubbers, filler agents, reinforcing agents, thickening agents, opacifiers, inhibitors, fluorescence markers, thermal degradation reducers, thermal resistance conferring agents, surfactants, wetting agents, conductive synergists, or stabilizers. For example, thickening agents and plasticizers such as vinyl chloride terpolymer and dimethyl sebacate respectively, can be used to modify the viscosity, elasticity, and robustness of a system. Additives can additionally provide mechanical reinforcement to the polymerized system.

Test Methods

Storage Modulus

A TA Instruments DHR-2 rheometer is used. Disposable 25 mm aluminum plates are used to evaluate each formulation. The bottom plate has an initiator solution applied on it using a Q-tip. The initiator solution is 50:50 wt. % Setalux 17-1453 (a tertiary acrylic amine) in butyl acetate. The plates are placed in an 80° C. oven for 10 minutes to allow the solvent to flash off. The plates are placed at room temperature to equilibrate before the monomer formulation is applied. The rheometer is started according to the operating procedure provided by TA instruments. The plates are zeroed before the test began. The PSA formulation is applied and the gap is lowered to 50 μm, and the test is started. Set up the method to hold the plates at 50 μm for three hours to allow for the formulation to cure. After three hours, a temperature sweep is started from −10° C.-100° C. The storage and lost moduli are recorded for the data point 25° C.

DSC (Tg)

A TA instruments DSC is used for the analysis. One drop of the initiator solution (50:50 wt. % Setalux 17-1453 in butyl acetate) is placed in the pan and the solvent is flashed off in the oven in a similar fashion to how the rheometer plates for Storage Modulus are prepared. One drop of monomer is placed in the DSC pan, and the pans are left to cure at room temperature for three hours before the lid is placed on it, and the pan is analyzed. After the three hours a heating and cooling cycle is applied to the pans from −80° C.-150° C., at 5 degrees per minute. The Tg is identified and analyzed for each sample. Thus, the Tg herein represents the Tg of the polymers such as homopolymers or the polymer segments in block copolymers and not of the starting monomers.

Peel, Tack, and Sheer Tests

Sample Preparation: A 1 mil polyurethane film is used to cast the samples on. The primer and initiator solutions are applied using an automatic drawdown bar. The draw down bar is a 10 mil wire Meyer rod. The resulting coating is roughly 25 μm. The films are cut from the roll of material to an 8×11 inch sheet. The initiator is applied first, and the films are transferred to the oven to allow for the solvent to flash off. The bar is cleaned with solvent between each application. The monomer formulation is drawn down, and samples sit at room temperature for 24 hours to cure. The specimens are then cut into 1 inch pieces to be used on the testing equipment.

The peel testing is done in accordance to ASTM D 3330D. The ASTM is modified to include 1 inch wide samples applied to HDPE substrate at a rate of 24 in./min with a 4.5 pound rubber covered roller. The samples are pulled at 180° at 12 in/min and the force required to peel the specimen off is recorded, averaged, and the failure mode is noted. Dynamic shear is tested per ASTM 1002 with a modification that includes using aluminum substrates for testing. Probe tack is measured in accordance to ASTM D 2979 using a Chemsultants PT-1000 probe tack tester.

### Examples

### Monomers

Monomer 1, a tacky polymer having a Tg of −60° C.:

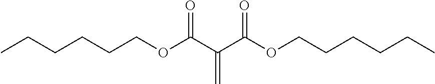 [SMILES: C=C(C(=O)OCCCCCC)C(=O)OCCCCCC]

Monomer 2, a rigid polymer having a Tg of 140° C.:

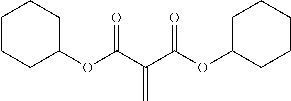 [SMILES: C=C(C(=O)OC1CCCCC1)C(=O)OC1CCCCC1]

Monomer 3, a multifunctional crosslinker:

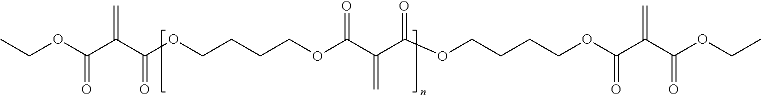

### Example 1

Solventless PSA compositions are shown in Table 1 below. The formulations are prepared to yield 30 g samples. The monomers are weighed out individually and the final formulations were mixed in a bottle manually.

TABLE 1

| Formulation | | | |
|---|---|---|---|
| Number | % Monomer 1 | % Monomer 2 | % Monomer 3 |
| 1 | 98.5 | 1 | 0.5 |
| 2 | 91.5 | 8 | 0.5 |
| 3 | 97.25 | 1 | 1.75 |
| 4 | 94.375 | 4.5 | 1.125 |
| 5 | 86.125 | 11.5 | 2.375 |
| 6 | 83.25 | 15 | 1.75 |
| 7 | 87.375 | 11.5 | 1.125 |
| 8 | 96 | 1 | 3 |
| 9 | 93.125 | 4.5 | 2.375 |
| 10 | 89 | 8 | 3 |
| 11 | 82 | 15 | 3 |
| 12 | 84.5 | 15 | 0.5 |

Table 2 includes various properties of the Formulations in Table 1, via the test methods described herein.

TABLE 2

| | | Tack | Tack | | Dynamic | Storage |
|---|---|---|---|---|---|---|
| Formulation | Tg | replicate 1 | replicate 2 | Peel | Shear | Modulus |
| Number | ° C. | g | g | g/inch | LBf/si | Pa |
| 1 | 18.7 | 35.6 | 67.2 | 498.7 | 8.4 | 63,291 |
| 2 | 7.08 | 46.8 | 12.5 | 467.4 | 9.2 | 14,362 |
| 3 | 18.44 | 105.8 | 102.3 | 270.3 | 4.3 | 5,209 |
| 4 | 16.36 | 27.2 | 93.2 | 70.4 | 20.8 | 14,710 |
| 5 | 17.35 | 1.9 | 1.2 | 104.2 | 30.3 | 23,593 |
| 6 | 20.13 | 1.2 | 1.9 | 113.1 | 32.4 | 13,918 |
| 7 | 16.36 | 1.2 | 1.2 | 115.2 | 2 | 181,197 |
| 8 | 17.84 | 1.2 | 0.5 | 25 | 27.7 | 34,208 |
| 9 | 18.61 | 1.2 | 1.2 | 41.1 | 25.9 | 37,779 |
| 10 | 21.42 | 1.2 | 0.5 | 57.1 | 31.1 | 47,450 |
| 11 | 6.74 | 0.5 | 1.2 | 40.2 | 35.6 | 32,189 |
| 12 | 10.24 | 1.2 | 0.5 | 198.4 | 16.3 | 154,095 |

Although the peel or tack is not optimized, the dynamic shear for formulations 4-6, and 8-12 showed high shear above a target of 4.4 psi. Optimal storage modulus according to Satas's 3^{rd} edition of Handbook of pressure sensitive adhesive technology is usually in the range of 10,000 Pa to 100,000 Pa. Most of the Formulations were in this range. Formulation 1 has the best balance of peel strength, shear strength and storage modulus.

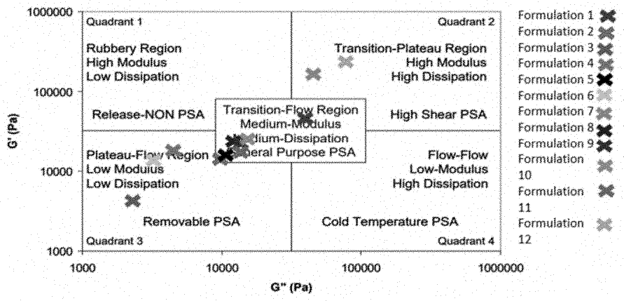

FIG. 1 depicts a comparison of the storage modulus and loss modulus of each of the formulations in Example 1 and overlays a graph showing the types of PSA which exhibit such moduli. As illustrated by FIG. 1, the solventless PSA compositions described herein can be formulated to form a variety of PSA adhesives including high shear PSAs, general purpose PSAs, and removable PSAs.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of aspects and examples has been presented for purposes of description. It is not intended to be exhaustive or limiting to the forms described. Numerous modifications are possible in light of the above teachings. Some of those modifications have been discussed and others will be understood by those skilled in the art. The aspects were chosen and described for illustration of various aspects. The scope is, of course, not limited to the examples or aspects set forth herein, but can be employed in any number of applications and equivalent articles by those of ordinary skill in the art. Rather it is hereby intended the scope be defined by the claims appended hereto.

It should be understood that certain aspects, features, structures, or characteristics of the various aspects can be interchanged in whole or in part. Reference to certain aspects mean that a particular aspect, feature, structure, or characteristic described in connection with certain aspects can be included in at least one aspect and may be interchanged with certain other aspects. The appearances of the phrase “in certain aspects” in various places in specification are not necessarily all referring to the same aspect, nor are certain aspects necessarily mutually exclusive of other certain aspects. It should also be understood that the steps of the methods set forth herein are not necessarily required to be performed in the orders described, and the order of the steps of such methods should be understood to be merely exemplary. Likewise, additional steps can be included in such methods, and certain steps may be omitted or combined, in methods consistent with certain aspects.

What is claimed is:

1. A solventless pressure sensitive adhesive composition comprising:
from about 65% to about 99.5%, by weight of a first monomer comprising 1,1-disubstituted alkene monomer of formula III, having a low Tg;
from about 0.5% to about 25%, by weight of a second monomer comprising 1,1-disubstituted alkene monomer of formula III, having an elevated Tg;
from about 0.1% to about 20% of a 1,1-disubstituted alkene multifunctional crosslinker;
wherein Formula III is 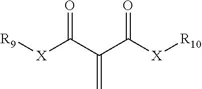
wherein R₉ and R₁₀ are the same or different and each represent a hydrocarbyl group and wherein each X is oxygen.

2. The composition of claim 1 wherein the low Tg is from about −60° C. to about 10° C. and the elevated Tg is from about 23° C. to about 150° C.

3. The composition of claim 2 wherein the hydrocarbyl groups of the first monomer are selected from the group including C₁₋₁₅ straight or branched chain alkyl groups and C₁₋₁₅ straight or branched chain alkenyl groups.

4. The composition of claim 3 wherein the hydrocarbyl group is C₁₋₈ straight or branched chain alkyl groups.

5. The composition of claim 1 wherein the hydrocarbyl group of the second monomer are selected from the group including C₅₋₁₈ cycloalkyl groups and C₆₋₂₄ alkyl substituted cycloalkyl groups.

6. The composition of claim 5 wherein the hydrocarbyl group of the second monomer is a C₆ cycloalkyl group.

7. The composition of claim 1 wherein the multifunctional crosslinker of 1,1-disubstituted alkene monomer has the formula: 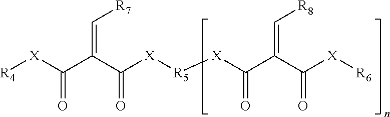
wherein each X is O; R₄ and R₆ can be the same or different C₁-C₄ alkyl; R₅ is the same or different C₁-C₈ alkyl; R₇ and R₈ are H; and n is an integer of 1 to 3.

8. The composition of claim 1, further comprising one or more compounds selected from the group including dyes, pigments, adhesion promotors, tackifiers, toughening agents, impact modifiers, rheology modifiers, plasticizing agents, natural or synthetic rubbers, filler agents, reinforcing agents, thickening agents, opacifiers, inhibitors, fluorescence markers, thermal degradation reducers, thermal resistance conferring agents, surfactants, and wetting agents.

9. A method of coating a substrate comprising providing a substrate having a surface and coating the substrate with the composition of claim 1.
